(19) United States
(12) Patent Application Publication
(10) Pub. No.: US 2012/0266202 A1
(43) Pub. Date: Oct. 18, 2012

(54) TELEVISION WITH INTERNAL INTERNET VIDEO STREAMING VIDEO BOX

(76) Inventors: Adrian Rosa, Kissimmee, FL (US); Maria Cabrera, Los Angeles, CA (US)

(21) Appl. No.: 13/086,768

(22) Filed: Apr. 14, 2011

(51) Int. Cl. H04N 21/426

(52) U.S. Cl. 725/110

(57) ABSTRACT

A television set with a television screen for displaying images. A processor is programmed to cause the images to be displayed on the television screen. An internally mounted Internet video streaming receiver box is connected to the processor and routes information from the Internet to the processor. A power supply provides power to the internally mounted Internet video streaming receiver box and the processor. In a preferred embodiment, the internally mounted Internet video streaming receiver box is a Roku® Internet video streaming receiver box.

The present invention relates to television sets, and in particular, to television sets that are connected to the Internet.

### BACKGROUND OF THE INVENTION

Internet video streaming receiver boxes are known in the prior art. An example of an Internet video streaming receiver box currently available is the Roku Internet video streaming receiver box made by the Roku Corporation with offices in Saratoga, Calif. ROKU is a federally registered trademark of the Roku Corporation and refers generally to Internet streaming receiver boxes.

Roku's currently available Internet streaming receiver boxes currently include the HD, which is the basic model of the line, offering 720 p resolution, 802.11 g WiFi reception (as well as an Ethernet connection) and an HDMI output. The middle of the line, the XD, adds 1080 p resolution (if channel programmers provide it), an enhanced remote with replay capabilities and single-band wireless N WiFi; the flagship model XDIS offers the same feature set as the XD, but also adds component video and optical audio outputs, dual-band wireless N and a USB port for playing videos, photos and music.

Content on the Roku DVP is provided by Roku partners, and is accessible to the user through assigned channels. Each separate channel supports content from one partner though some content partners have more than one channel. Users can add or remove different channels from the Roku Channel Store.

The Roku is an open-platform device with a freely available software development kit (SDK) that enables anyone to create new channels. Developers who wish to test their channels before a general release, or who wish to limit viewership, can create “private” channels that require a code be entered by the user in the account page of the Roku website.

The Roku Internet video streaming receiver box has revolutionized the manner in which individuals watch television. Individuals can now be much more selective about the shows viewed via their television set. The viewer may watch any show he wishes, so long as it is available through one Roku's partners. The following is a list of some of the current channels provided by some of the Roku partners:

### Premium Channels

Hulu Plus (U.S. only)

Netflix (U.S. and Canada only)

Amazon Instant Video

UFC

MLB.TV

WealthTV

FlickStream.TV

SportSkool Fitness

SportSkool Yoga

RaceFansTV

Movie Vault

Kung Fu Theater

Drive-In Classics

Cowboy Classics

Moonlight Movies

Midwest Cage Championship (MCC)

Weiss Money Network

Mobile Tribe

Channels with Both Free and Premium Programming

MP3tunes

Bigstar.tv

EZTakes

MHz Networks

Dream TV

### Free Channels

Sunimi

Roku Newscaster

Revision3

TWiT.tv (network)

Mediafly

NASA TV

blubrry

CNET TV

Crunchyroll

Frame Channel

techpodcasts.com

Spacevidcast

blip.tv

Pandora Radio

Life+Health Network

Roxwel

Radio Time

Radio Paradise

Blastro

Proud Television

The Highway Girl

Break.com

CDNTwo

Liberty News Radio

Film Fun

Tagesschau (Germany)

Gospel Broadcasting Network (GBN)

USB Media Player

FIG. 1 shows the prior art method of connecting Internet video streaming receiver box 2 to television set 3. Box 2 is connected to power source 4 via power cable 5. VGA cables 6 connect box 2 to television set 3. Box 2 is connected to the Internet via wire connection 7 or alternatively through a wire connection. The system shown in FIG. 1 works efficiently for connecting the viewer to the Internet so that he can access the partner provided channels. However, the connective method is unattractive and cumbersome because box 2 is located exterior to and away from television set 2. VGA cables 6 are visible and also unattractive and cumbersome.

What is needed is a better way of connecting an Internet video streaming receiver box to a television set.

### SUMMARY OF THE INVENTION

The present invention provides a television set with a television screen for displaying images. A processor is programmed to cause the images to be displayed on the television screen. An internally mounted Internet video streaming receiver box is connected to the processor and routes information from the Internet to the processor. A power supply provides power to the internally mounted Internet video streaming receiver box and the processor. In a preferred embodiment, the internally mounted Internet video streaming receiver box is a Roku® Internet video streaming receiver box.

### BRIEF DESCRIPTION OF THE DRAWINGS

FIG. 1 shows a prior art connection of a Roku® Internet video streaming receiver box.

FIG. 2 shows a first preferred embodiment of the present invention.

FIG. 3 shows a second preferred embodiment of the present invention.

FIG. 4 shows remote control of the present invention.

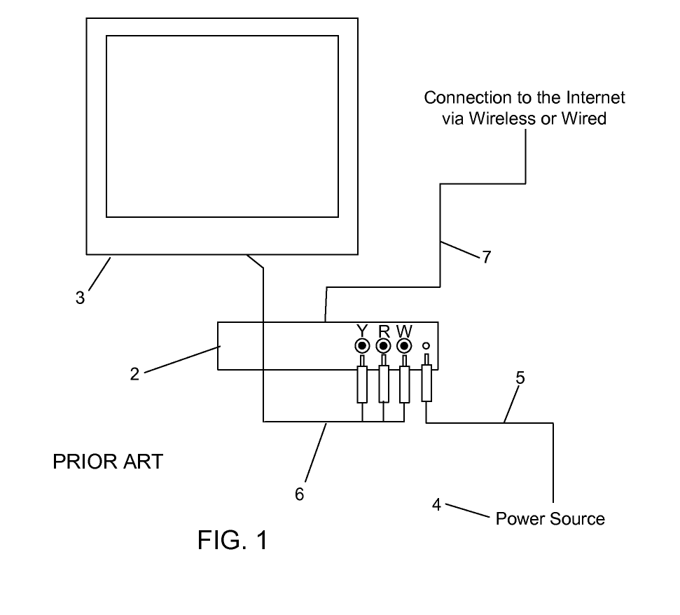

### DETAILED DESCRIPTION OF THE PREFERRED EMBODIMENTS

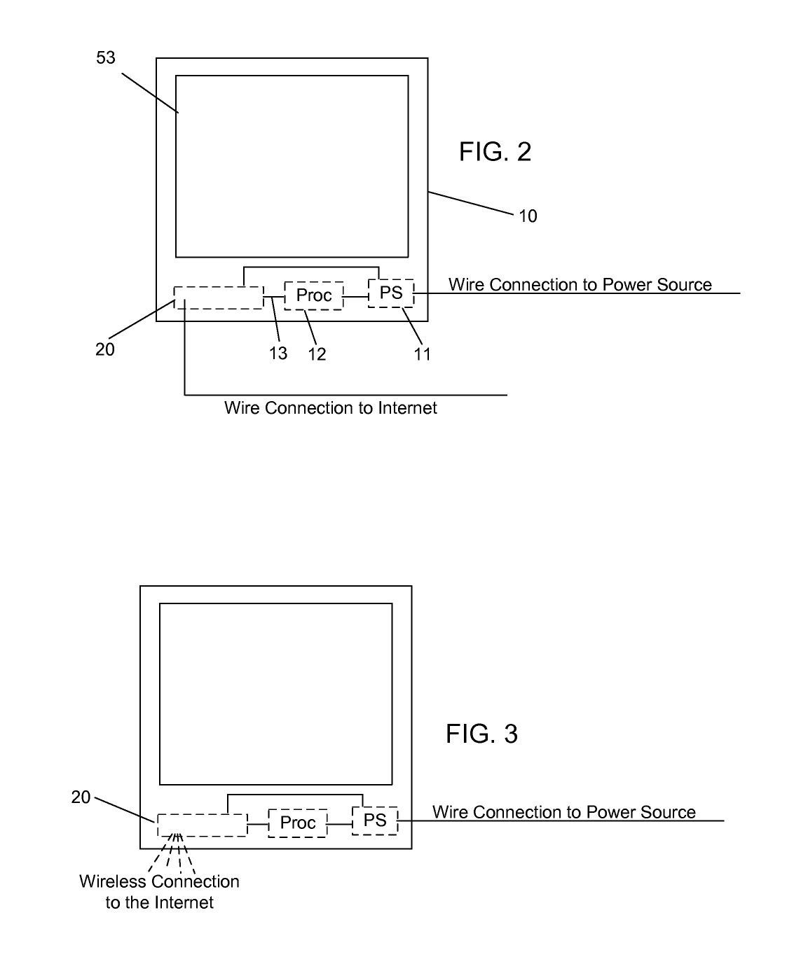

FIG. 2 shows a first preferred embodiment of the present invention. Internet video streaming receiver box 20 has been mounted internally to television set 10 having screen 53. In a preferred embodiment, box 20 is a Roku® Internet video streaming receiver box. Box 20 receives its power directly from television power supply 11. An external power source provides power to television power supply 11. In contrast to the prior art, external VGA cables 6 are not necessary for connecting box 20 to television 10. Instead, video signals are transmitted from box 20 to processor 12 of television 10 directly through an internal wire connection 13.

FIG. 3 shows a second preferred embodiment of the present invention. In the second preferred embodiment box 20 is connected to the Internet via a wireless connection.

It should be noted that box 20 can be placed inside any type of television set, including modern LCD and LED television sets. In each case, the internally mounted box 20 is a far superior option to the prior art utilization of box 2 as described in the Background section. The appearance is sleeker and more attractive. Less space is taken because box 20 is mounted internally. There are no unsightly external wires connecting an external box to the television.

### Increased Signal Strength

Because there is a more direct connection between box 20 and processor 12, there is increased signal strength which increases the quality of images displayed on screen 53. As stated above the elimination of VGA cables 6 allows for the direct connection via wire 13 (FIG. 2).

### Remote Control

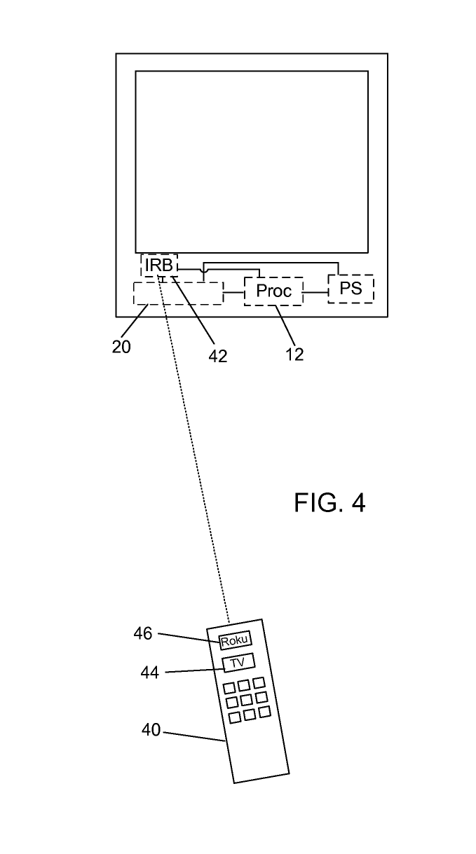

As shown in FIG. 4, in another preferred embodiment IR a single remote control device 40 controls both box 20 and the standard television controls. IR board 42 receives the IR signal from remote control device 40 and provides inputs to box 20 and processor 12.

The user selects which device to control by pressing either button 44 or button 46 on remote control device 40.

### Sleep Mode

Power supply 11 is always connected to box 20 which allows box 20 to operate in “sleep mode” when the television is turned off. This allows the user to resume operating box 20 from its last position rather than having to reboot box 20 whenever the television is turned on.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention

What is claimed is:

1. A television set, comprising
A. a television screen,
B. a processor programmed to cause images to be displayed on said television screen,
C. an internally mounted Internet video streaming receiver box connected to said processor and providing information from the Internet to said processor,
D. a power supply for providing power to said internally mounted Internet video streaming receiver box and for providing power to said processor.

2. The television set as in claim 1 wherein said internally mounted Internet video streaming receiver box is a Roku® Internet video streaming receiver box.

3. The television set as in claim 1, wherein said television set is LCD television set.

4. The television set as in claim 1, wherein said television set is a LED television set.
